(19) United States
(12) Patent Application Publication
(10) Pub. No.: US 2023/0315611 A1
(43) Pub. Date: Oct. 5, 2023

(54) BUG-DETECTION ASSISTING DEVICE, BUG-DETECTION ASSISTING METHOD, AND BUG-DETECTION ASSISTING PROGRAM

(71) Applicant: NIPPON TELEGRAPH AND TELEPHONE CORPORATION, Tokyo (JP)

(72) Inventors: Yuma KUROGOME, Musashino-shi, Tokyo (JP); Makoto IWAMURA, Musashino-shi, Tokyo (JP); Jun MIYOSHI, Musashino-shi, Tokyo (JP)

(73) Assignee: NIPPON TELEGRAPH AND TELEPHONE CORPORATION, Tokyo (JP)

(21) Appl. No.: 18/022,749

(22) PCT Filed: Sep. 14, 2020
(86) PCT No.: PCT/JP2020/034796

§ 371 Date: Feb. 23, 2023

(51) Int. Cl. G06F 11/36

(52) U.S. Cl. CPC G06F 11/3644; G06F 11/3624

(57) ABSTRACT

A profile unit of a bug detection support apparatus specifies a plurality of hot paths indicating functions which frequently execute individual processing by executing a compiled binary file. The profile unit specifies, under a constraint condition that a total execution time of hot paths to which a bug detection tool is applied and hot paths to which the bug detection tool is not applied is shorter than a predetermined time, a combination of a hot path to which the bug detection tool is applied and a hot path to which the bug detection tool is not applied by obtaining a solution of an objective function which maximizes the number of the hot paths to which the bug detection tool is applied and minimizes the total execution time. A rewriting unit of the bug detection support apparatus rewrites an intermediate expression of the binary file.

### TECHNICAL FIELD

The present invention relates to a bug detection support apparatus, a bug detection support method, and a bug detection support program.

### BACKGROUND ART

Many programs may include bugs caused due to improper memory operations. In a case where a bug is included in a program, the bug not only interrupts an action of a normal operation of the program but also causes vulnerability.

For example, as a technique for detecting a bug in the related art, there is a tool called an address sanitizer (ASAN). The ASAN adds a code for supporting bug detection due to an improper memory operation to a program when compiling and linking the program, and dynamically links a library file including the code to the program.

### CITATION LIST

### Non Patent Literature

Non Patent Literature 1: Matthias Wenzl, Georg Merzdovnik, and Johanna Ullrich, From Hack to Elaborate Technique-A Survey on Binary Rewriting. ACM Computing Surveys, Vol. 52, No. 3, Article 49 (June 2019). 37 pages.

### SUMMARY OF INVENTION

### Technical Problem

However, in the above-described technique (ASAN) in the related art, application targets are limited, and an execution speed of a source code after application of ASAN is reduced to 3 to 50 times the execution speed before application. As a result, it is necessary to examine a portion to which ASAN is applied.

An object of the present invention is to expand an application range of a bug detection tool such as ASAN and support bug detection without causing a decrease in an execution speed of a source code.

### Solution to Problem

To solve the above-described problems and achieve the object, according to the present invention, there is provided a bug detection support apparatus including: a first specifying unit that specifies a plurality of hot paths indicating functions which frequently execute individual processing by executing a compiled binary file; a second specifying unit that specifies, under a constraint condition that a total execution time of hot paths to which a bug detection tool is applied and hot paths to which the bug detection tool is not applied is shorter than a predetermined time, a combination of a hot path to which the bug detection tool is applied and a hot path to which the bug detection tool is not applied among the plurality of hot paths by obtaining a solution of an objective function which maximizes the number of the hot paths to which the bug detection tool is applied and minimizes the total execution time; and a rewriting unit that rewrites an intermediate expression of the binary file based on a result of the combination specified by the second specifying unit.

### Advantageous Effects of Invention

According to the present invention, it is possible to expand an application range of a bug detection tool such as ASAN and support bug detection without causing a decrease in an execution speed of a source code.

### BRIEF DESCRIPTION OF DRAWINGS

FIG. 1 is a functional block diagram illustrating a configuration of a bug detection support apparatus according to the present embodiment.

FIG. 2 is a diagram illustrating a configuration of a profile unit.

FIG. 3 is a diagram for explaining processing of a solver.

FIG. 4 is a diagram illustrating a configuration of an analysis unit.

FIG. 5 is a diagram illustrating a configuration of a rewriting unit.

FIG. 6 is a diagram illustrating a configuration of an output unit.

FIG. 7 is a flowchart illustrating a processing procedure of the bug detection support apparatus according to the present embodiment.

FIG. 8 is a diagram illustrating an example of a computer that executes a bug detection support program.

### DESCRIPTION OF EMBODIMENTS

Hereinafter, embodiments of a bug detection support apparatus, a bug detection support method, and a bug detection support program disclosed in the present application will be described in detail with reference to the drawings. Note that the present invention is not limited by the embodiment.

### EMBODIMENT

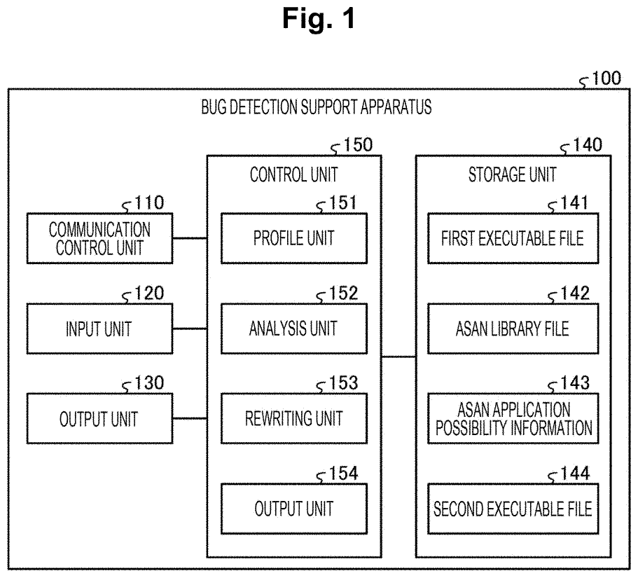

FIG. 1 is a functional block diagram illustrating a configuration of a bug detection support apparatus according to the present embodiment. As illustrated in FIG. 1, a bug detection support apparatus 100 includes a communication control unit 110, an input unit 120, an output unit 130, a storage unit 140, and a control unit 150.

The communication control unit 110 is realized by a network interface card (NIC) or the like, and controls communication between an external apparatus and the control unit 150 via a telecommunication line such as a local area network (LAN) or the Internet.

The input unit 120 is realized by using an input device such as a keyboard or a mouse, and inputs various kinds of instruction information such as a processing start to the control unit 150 in response to input operations of an operator. The output unit 130 is realized by a display device such as a liquid crystal display, a printing device such as a printer, or the like.

The storage unit 140 includes a first executable file 141, an ASAN library file 142, ASAN application possibility information 143, and a second executable file 144. The storage unit 140 is realized by a semiconductor memory element such as a random access memory (RAM) or a flash memory or a storage device such as a hard disk or an optical disk.

The first executable file 141 is an executable file obtained by compiling a source code. In the present embodiment, as an example, it is assumed that the compiled first executable file 141 is stored in the storage unit 140.

The ASAN library file 142 is a function provided by an operating system, and is particularly file information including a function for applying ASAN.

The ASAN application possibility information 143 is information indicating a possibility of a function to which ASAN is applied.

The second executable file 144 is an executable file to which an ASAN library file is dynamically linked.

The control unit 150 includes a profile unit 151, an analysis unit 152, a rewriting unit 153, and an output unit 154. The control unit 150 corresponds to a central processing unit (CPU) or the like.

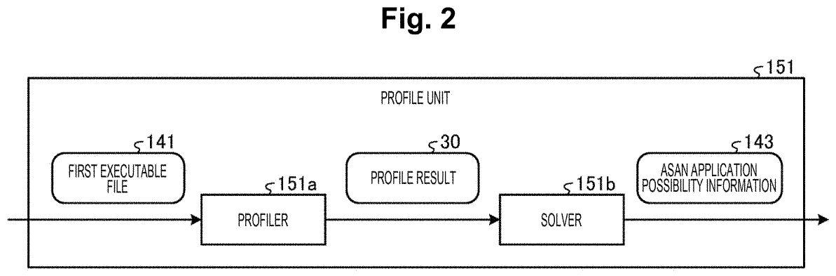

The profile unit 151 is a processing unit that generates the ASAN application possibility information 143 based on the first executable file 141. FIG. 2 is a diagram illustrating a configuration of the profile unit. As illustrated in FIG. 2, the profile unit 151 includes a profiler 151a and a solver 151b.

The profiler 151a specifies a hot path by executing the first executable file 141. The hot path indicates a function that frequently executes individual processing (a function for executing individual processing a predetermined number of times or more). The profiler 151a outputs, as a profile result 30, information of the specified hot path to the solver 151b. The profiler 151a corresponds to a tool such as Perf.

The solver 151b obtains a solution that maximizes or minimizes an objective function, among solutions that satisfy constraint conditions. For example, the solver 151b acquires the profile result 30, and specifies a combination of a hot path to which ASAN is applied and a hot path to which ASAN is not applied among a plurality of hot paths by obtaining a solution of an objective function that maximizes the number of hot paths to which ASAN is applied and minimizes a total execution time under a constraint condition that the total execution time of the hot path to which ASAN is applied and the hot path to which ASAN is not applied is shorter than a predetermined time. As the ASAN application possibility information 143, information of the combination of a hot path to which ASAN is applied and a hot path to which ASAN is not applied is used.

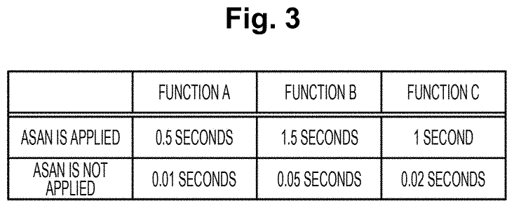

FIG. 3 is a diagram for explaining processing of the solver. For example, it is assumed that a hot path is a function A, a function B, and a function C. It is assumed that an execution time of the function A in a case where ASAN is applied to the function A is “0.5 seconds.” It is assumed that an execution time of the function A in a case where ASAN is not applied to the function A is “0.01 seconds.” It is assumed that an execution time of the function B in a case where ASAN is applied to the function B is “1.5 seconds.” It is assumed that an execution time of the function B in a case where ASAN is not applied to the function B is “0.05 seconds.” It is assumed that an execution time of the function C in a case where ASAN is applied to the function C is “1 second.” It is assumed that an execution time of the function C in a case where ASAN is not applied to the function C is “0.02 seconds.”

For example, it is assumed that the constraint condition given to the solver 151b is “the total execution time of programs (functions A to C) is within 2 seconds.” Further, it is assumed that the objective function given to the solver 151b is for “maximization of the number of functions to which ASAN is applied” and “minimization of the total execution time of programs.” In a case where the constraint condition and the objective function are given, the solver 151b outputs, as the ASAN application possibility information 143, information of a combination of “Function A: ASAN is applied, Function B: ASAN is not applied, and Function C: ASAN is applied.”

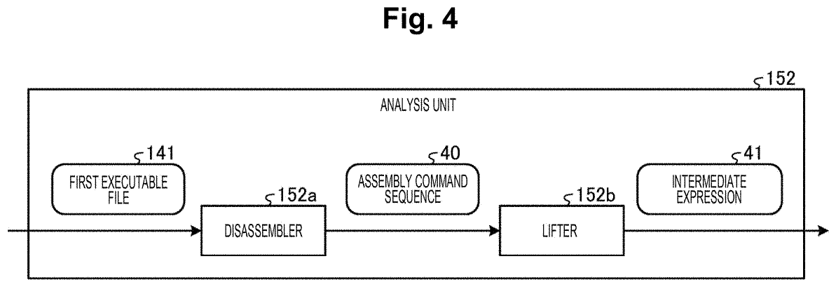

The description returns to FIG. 1. The analysis unit 152 converts the first executable file 141 into an intermediate expression. FIG. 4 is a diagram illustrating a configuration of the analysis unit. As illustrated in FIG. 4, the analysis unit 152 includes a disassembler 152a and a lifter 152b.

In a case where the first executable file 141 is input, the disassembler 152a restores an assembly command sequence 40, and outputs the restored assembly command sequence 40 to the lifter 152b. The assembly command sequence 40 is information in which commands for giving instructions to an assembler are arranged.

In a case where the assembly command sequence 40 is input, the lifter 152b converts the assembly command sequence 40 into an intermediate expression 41. The lifter 152b outputs the intermediate expression 41 to the rewriting unit 153 to be described later. The intermediate expression 41 has a data structure such as text data or binary data.

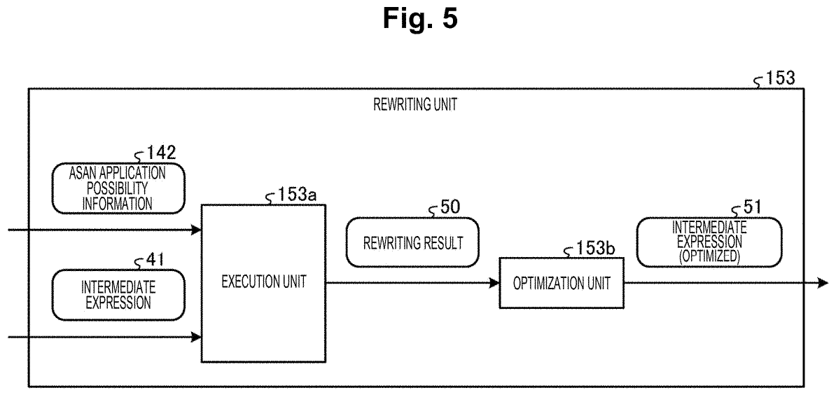

The description returns to FIG. 1. The rewriting unit 153 adds, to the intermediate expression 41, a reference to the ASAN library file 142. FIG. 5 is a diagram illustrating a configuration of the rewriting unit. As illustrated in FIG. 5, the rewriting unit 153 includes an execution unit 153a and an optimization unit 153b.

The execution unit 153a rewrites the intermediate expression 41 by adding, to the intermediate expression 41, a reference to the ASAN library file based on the ASAN application possibility information 143. The execution unit 153a outputs a rewriting result 50 to the optimization unit 153b.

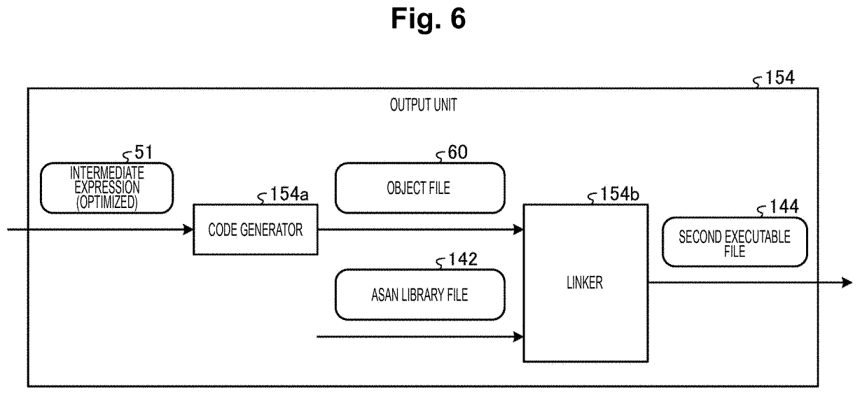

For example, the execution unit 153a specifies a function to which ASAN is applied, among functions included in the intermediate expression 41, based on the functions included in the intermediate expression 41 and the ASAN application possibility information 143. The execution unit 153a rewrites the intermediate expression 41 by adding, to the function to which ASAN is applied, a reference to the ASAN library file. The execution unit 153a sets an embedding mark or the like for the intermediate expression (the intermediate expression is converted into an object file in a code generator 154a), and a subsequent linker 154b performs embedding of an external reference into the mark. The code generator 154a is illustrated in FIG. 6 to be described later.

The optimization unit 153b generates an optimized intermediate expression 51 by performing various types of optimization on the rewriting result 50 (intermediate expression). For example, the optimization unit 153b executes, as optimization, a method of enhancing efficiency of the program or a method of obfuscating the program. The optimization unit 153b outputs the intermediate expression 51 to the output unit 154.

The description returns to FIG. 1. The output unit 154 generates the second executable file 144 based on the optimized intermediate expression 51. FIG. 6 is a diagram illustrating a configuration of the output unit. As illustrated in FIG. 6, the output unit 154 includes a code generator 154a and a linker 154b.

The code generator 154a converts the intermediate expression 51 into an object file 60 based on a predetermined conversion rule. The code generator 154a outputs the object file 60 to the linker 154b.

The linker 154b receives, as an input, the object file 60 and the ASAN library file 142, and generates the second executable file 144. The linker 154b outputs the second executable file 144. The link to be executed by the linker 154b includes a static link and a dynamic link.

The static link is a link method of embedding, into the object file 60, an application programming interface (API) itself included in the ASAN library file 142. In the static link, the API can be executed even in an environment in which the ASAN library file 142 does not exist.

The dynamic link is a link method of embedding, into the object file 60, an external reference to the ASAN library file 142. A library file name and an API name desired to be used are embedded into the external reference. In execution of the program, a corresponding library file and a corresponding API are automatically searched for and then executed.

For example, a reference to the ASAN library file 142 rewritten in a stage of the intermediate expression is added to the object file 60, and the reference is replaced with the external reference.

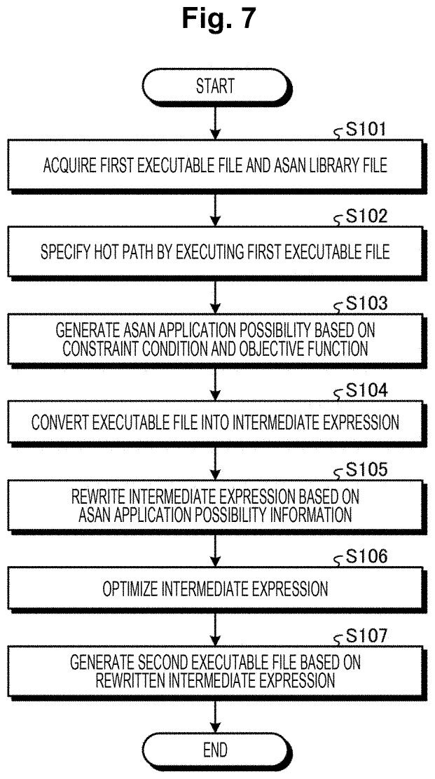

Next, an example of a processing procedure of the bug detection support apparatus according to the present embodiment will be described. FIG. 7 is a flowchart illustrating a processing procedure of the bug detection support apparatus according to the present embodiment. As illustrated in FIG. 7, the bug detection support apparatus 100 acquires the first executable file 141 and the ASAN library (step S101).

The profile unit 151 of the bug detection support apparatus 100 specifies a hot path by executing the first executable file 141 (step S102). The profile unit 151 generates the ASAN application possibility information 143 based on the constraint condition and the objective function (step S103).

The analysis unit 152 of the bug detection support apparatus 100 converts the executable file into an intermediate expression (step S104). The rewriting unit 153 of the bug detection support apparatus 100 rewrites the intermediate expression based on the ASAN application possibility information 143 (step S105). The rewriting unit 153 optimizes the intermediate expression (step S106).

The output unit 154 of the bug detection support apparatus 100 generates the second executable file 144 based on the rewritten intermediate expression (step S107).

Next, effects of the bug detection support apparatus 100 according to the present embodiment will be described. The bug detection support apparatus 100 specifies a hot path by executing the compiled executable file, and specifies a combination of a hot path to which ASAN is applied and a hot path to which ASAN is not applied among a plurality of hot paths by obtaining a solution of an objective function that maximizes the number of hot paths to which ASAN is applied and minimizes a total execution time under a constraint condition that the total execution time of the hot path to which ASAN is applied and the hot path to which ASAN is not applied is shorter than a predetermined time. Thereby, ASAN can be applied only to a function that is frequently executed and a decrease in speed is not caused due to ASAN.

The bug detection support apparatus 100 converts a binary file into an intermediate expression, and rewrites the intermediate expression of the executable file based on a result of the specified combination. Thereby, an application range of ASAN can be expanded.

The bug detection support apparatus 100 converts the rewritten intermediate expression into an executable file again. Therefore, an executable file to which ASAN is applied can be generated.

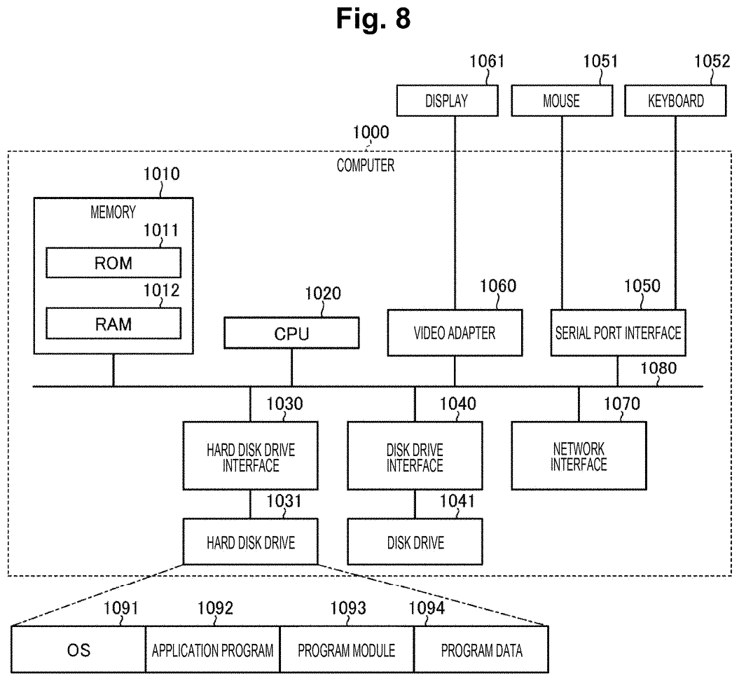

FIG. 8 is a diagram illustrating an example of a computer that executes a bug detection support program. A computer 1000 includes, for example, a memory 1010, a CPU 1020, a hard disk drive interface 1030, a disk drive interface 1040, a serial port interface 1050, a video adapter 1060, and a network interface 1070. These units are connected to each other by a bus 1080.

The memory 1010 includes a read only memory (ROM) 1011 and a RAM 1012. The ROM 1011 stores, for example, a boot program such as a basic input output system (BIOS). The hard disk drive interface 1030 is connected to a hard disk drive 1031. The disk drive interface 1040 is connected to a disk drive 1041. For example, a removable storage medium such as a magnetic disk or an optical disc is inserted into the disk drive 1041. A mouse 1051 and a keyboard 1052 are connected to, for example, the serial port interface 1050. A display 1061 is connected to, for example, the video adapter 1060.

Here, the hard disk drive 1031 stores, for example, an OS 1091, an application program 1092, a program module 1093, and program data 1094. Each piece of information described in the above embodiment is stored in, for example, the hard disk drive 1031 or the memory 1010.

In addition, the bug detection support program is stored in, for example, the hard disk drive 1031 as the program module 1093 in which commands to be executed by the computer 1000 are described. Specifically, the program module 1093 in which each piece of processing to be executed by the bug detection support apparatus 100 described in the above embodiment is described is stored in the hard disk drive 1031.

Further, data to be used for information processing performed by the bug detection support program is stored in, for example, the hard disk drive 1031, as the program data 1094. Then, the CPU 1020 reads, into the RAM 1012, the program module 1093 and the program data 1094 stored in the hard disk drive 1031 as necessary, and executes each procedure described above.

Note that the program module 1093 and the program data 1094 related to the bug detection support program are not limited to being stored in the hard disk drive 1031, and may be stored in, for example, a removable storage medium and may be read by the CPU 1020 via the disk drive 1041 or the like. Alternatively, the program module 1093 and the program data 1094 related to the bug detection support program may be stored in another computer connected via a network such as LAN or a wide area network (WAN), and may be read by the CPU 1020 via the network interface 1070.

Although the embodiments to which the invention made by the present inventor is applied have been described above, the present invention is not limited by the description and the drawings as a part of the disclosure of the present invention according to the embodiments. In other words, other embodiments, examples, operation techniques, and the like made by those skilled in the art and the like based on the embodiments are all included in the scope of the present invention.

### REFERENCE SIGNS LIST

100 Bug detection support apparatus
110 Communication control unit
120 Input unit
130 Output unit
140 Storage unit
141 First executable file
142 ASAN library file
143 ASAN application possibility information
144 Second executable file
150 Control unit
151 Profile unit
152 Analysis unit
153 Rewriting unit
154 Output unit

1. A bug detection support apparatus, comprising:
first specifying circuitry configured to specify a plurality of hot paths indicating functions which frequently execute individual processing by executing a compiled binary file;
second specifying circuitry configured to specify, under a constraint condition that a total execution time of hot paths to which a bug detection tool is applied and hot paths to which the bug detection tool is not applied is shorter than a predetermined time, a combination of a hot path to which the bug detection tool is applied and a hot path to which the bug detection tool is not applied among the plurality of hot paths by obtaining a solution of an objective function which maximizes the number of the hot paths to which the bug detection tool is applied and minimizes the total execution time; and
rewriting circuitry configured to rewrite an intermediate expression of the binary file based on a result of the combination specified by the second specifying unit.

2. The bug detection support apparatus according to claim 1, further comprising:
analysis circuitry configured to convert the binary file into an intermediate expression.

3. The bug detection support apparatus according to claim 1, further comprising:
output circuitry configured to convert the intermediate expression rewritten by the rewriting unit into a binary file again.

4. A bug detection support method, comprising:
first specifying a plurality of hot paths indicating functions which frequently execute individual processing by executing a compiled binary file;
second specifying, under a constraint condition that a total execution time of hot paths to which a bug detection tool is applied and hot paths to which the bug detection tool is not applied is shorter than a predetermined time, a combination of a hot path to which the bug detection tool is applied and a hot path to which the bug detection tool is not applied among the plurality of hot paths by obtaining a solution of an objective function which maximizes the number of the hot paths to which the bug detection tool is applied and minimizes the total execution time; and
rewriting an intermediate expression of the binary file based on a result of the combination specified by the second specifying.

5. A non-transitory computer readable medium storing a bug detection support program for causing a computer to execute a process, comprising:
first specifying a plurality of hot paths indicating functions which frequently execute individual processing by executing a compiled binary file;
second specifying, under a constraint condition that a total execution time of hot paths to which a bug detection tool is applied and hot paths to which the bug detection tool is not applied is shorter than a predetermined time, a combination of a hot path to which the bug detection tool is applied and a hot path to which the bug detection tool is not applied among the plurality of hot paths by obtaining a solution of an objective function which maximizes the number of the hot paths to which the bug detection tool is applied and minimizes the total execution time; and
rewriting an intermediate expression of the binary file based on a result of the combination specified by the second specifying procedure.

6. The method according to claim 3, further comprising:
converting the binary file into an intermediate expression.

7. The method according to claim 3, further comprising:
converting the intermediate expression rewritten by the rewriting unit into a binary file again.

8. The non-transitory computer readable medium according to claim 5, wherein the process further comprises:
converting the binary file into an intermediate expression.

9. The non-transitory computer readable medium according to claim 5, wherein the process further comprises:
converting the intermediate expression rewritten by the rewriting unit into a binary file again.
